(19) United States
(12) Patent Application Publication
(10) Pub. No.: US 2016/0110805 A1
(43) Pub. Date: Apr. 21, 2016

(54) DEVICE, METHOD, AND COMPUTER-READABLE MEDIUM FOR MANAGING A FLOW OF DATA BETWEEN INFORMATION STORAGE SERVERS OF INFORMATION STORAGE ENTITIES

(71) Applicant: Crispin LUNA, Altadena, CA (US)

(72) Inventor: Crispin LUNA, Altadena, CA (US)

(21) Appl. No.: 14/885,680

(22) Filed: Oct. 16, 2015

Related U.S. Application Data
(60) Provisional application No. 62/064,907, filed on Oct. 16, 2014.

(51) Int. Cl. G06Q 40/02

(52) U.S. Cl. CPC G06Q 40/025

(57) ABSTRACT

A device, method, and computer-readable medium for managing a flow of data between information storage servers of information storage entities that initiate a rent report which includes the data in response to receiving an initiation request from a client device. An enrollment path is determined for the rent report based on an originating enrollment venue associated with the initiation request. One or more elements of the data are based on one or more validation criteria, and the data is transformed to a predetermined format corresponding to one or more formats. The data is output to one of the information storage servers of one of the information storage entities.

### CROSS-REFERENCE TO RELATED APPLICATIONS

The present application claims the benefit of the earlier filing date of U.S. provisional application 62/064,907 filed in the U.S. Patent and Trademark Office on Oct. 16, 2014, the entire contents of which being incorporated herein by reference.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

A credit report is a record of a borrower's credit history from multiple sources including banks, credit card companies, credit agencies, and governments. When a person applies for a loan, such as a mortgage, the credit report is used as part of an overall credit analysis to determine a loan amount, interest rate, and the like. In addition, a rental payment history verification is also performed during mortgage underwriting as an indicator of a borrower's ability to consistently make mortgage payments.

### SUMMARY

In an exemplary implementation, a device, method, and computer-readable medium for managing a flow of data between information storage servers of information storage entities initiate a rent report which includes the data in response to receiving an initiation request from a client device. An enrollment path is determined for the rent report based on an originating enrollment venue associated with the initiation request. One or more elements of the data are based on one or more validation criteria, and the data is transformed to a predetermined format corresponding to one or more formats. The data is output to one of the information storage servers of one of the information storage entities.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary diagram of a rent reporting system, according to certain embodiments;

FIG. 2 is an exemplary diagram of a rent reporting trade line, according to certain embodiments;

FIG. 3 is an exemplary functional block diagram of a lending industry structure, according to certain embodiments;

FIG. 4 is a block diagram of an exemplary loan approval process, according to certain embodiments;

FIG. 5 is a flowchart of an exemplary rent reporting process, according to certain embodiments;

FIG. 6 is a diagram illustrating enrollment paths of the rent reporting system, according to certain embodiments;

FIG. 7 is an exemplary block diagram of a server, according to certain embodiments;

FIG. 8 is an exemplary schematic diagram of a data processing system, according to certain embodiments; and

FIG. 9 is an exemplary schematic diagram of a processor, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Aspects of this disclosure are directed to a device and method for reporting rent payment data to one or more credit bureaus, which can be interchangeably referred to as information storage entities throughout the disclosure. In certain embodiments, the rent payment data is merged into a credit report to show credit worthiness or unworthiness of a particular individual involved in a credit granting decision. For example, the device receives a request to provide the rental payment data to a credit bureau on behalf of a renter, landlord, property manager, or owner. In one implementation, the request is received from a realtor or mortgage broker when mortgage underwriting is performed. The rental payment history can be added as a trade line on a renter's credit report as an indicator of credit worthiness or unworthiness.

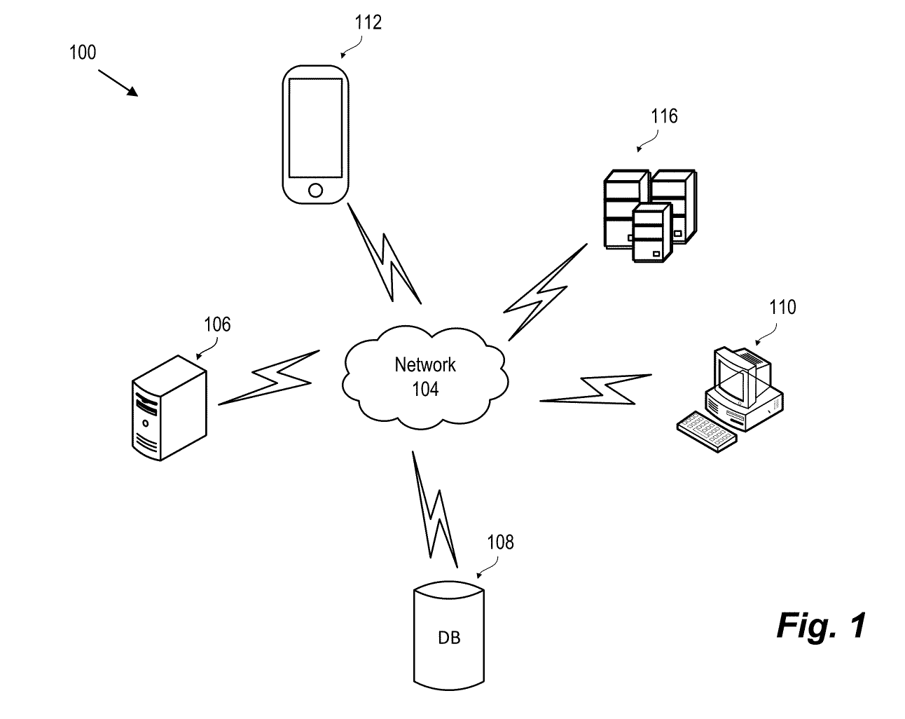

FIG. 1 is an exemplary illustration of a rent reporting system 100, according to certain embodiments. The computer 110 represents one or more computers 110 and acts as a client device that is connected to a server 106, a database 108, a mobile device 112, and one or more backend computing devices 116, via a network 104. In some implementations, the computer 110 is used by a renter, landlord, mortgage broker, or realtor to input rental credit data, including rental payment history data, for processing by the rent reporting system 100. For example, when a renter applies for a mortgage, the mortgage broker may complete an underwriting and transmittal summary document, such as a FNMA Form 1108/1003, and/or a verification of rent (VOR) form at a loan origination software (LOS) interface at the computer 110. In addition, a renter, landlord, or property manager can input the rental credit data directly at a web service interface at the computer 110. The web service interface can include a representational state transfer (REST) application program interface (API) and/or a simple object access protocol (SOAP) API. In some implementations, the rental credit data includes property data, ownership data, property management data, renter identity data, rental payment history data, and an electronic signature.

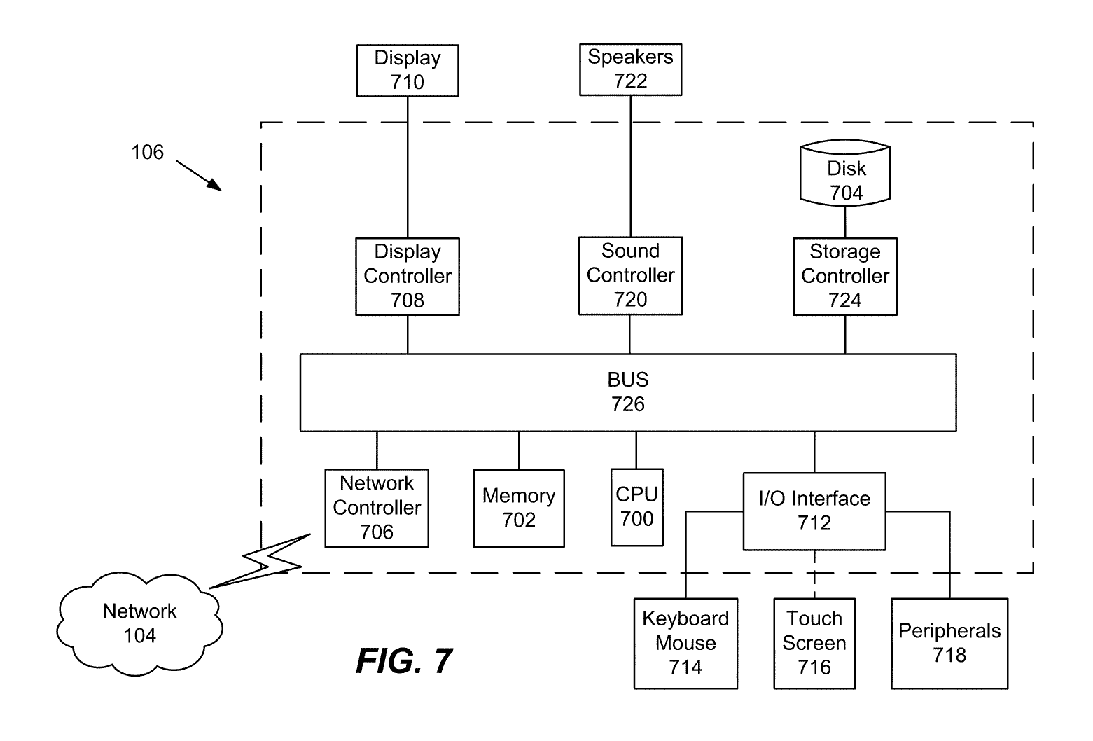

The server 106 represents one or more servers connected to the computer 110, the database 108, the mobile device 112, and the backend computing devices 116 via the network 104. In some implementations, processing circuitry of the server 106 initiates a credit bureau rent report in response to receiving an initiation request from the computer 110 and/or mobile device 112, determines an enrollment path for the rental credit data in the credit bureau rent report, validates and transforms the rental credit data into formats corresponding to credit report formats for one or more credit bureaus, and outputs the rental credit data to the credit bureaus. Note that each of the functions of the described embodiments may be implemented by one or more processing circuits. A processing circuit includes a programmed processor (for example, processor 700 of FIG. 7), as a processor includes circuitry. A processing circuit/circuitry may also include devices such as an application specific integrated circuit (ASIC) and conventional circuit components arranged to perform the recited functions. The processing circuitry can be referred to interchangeably as circuitry throughout the disclosure.

The database 108 represents one or more databases connected to the computer 110, the server 106, the mobile device 112, and the backend computing devices 116 via the network 104. In some implementations, the rental credit data reported by the renter, landlord, mortgage broker, and/or realtor can be stored in the database 108. In addition, the database 108 can also store credit reports for users before and after the rental credit data has been submitted to credit reporting agencies (CRAs) so that a credit score improvement can be determined based on the reporting of the rental credit data to the CRAs.

The mobile device 112 represents one or more mobile devices connected to the computer 110, the server 106, the database 108, and the backend computing devices 116 via the network 104. The network 104 represents one or more networks, such as the Internet, connecting the computer 110, the server 106, the database 108, and the mobile device 112. The network 104 can also communicate via wireless networks such as WI-FI, BLUETOOTH, cellular networks including EDGE, 3G and 4G wireless cellular systems, or any other wireless form of communication that is known.

As would be understood by one of ordinary skill in the art, based on the teachings herein, the mobile device 112 or any other external device could also be used in the same manner as the computer 110 to input rental credit data to the rent reporting system 100. In addition, the computer 110 and mobile device 112 can be referred to interchangeably as a client device throughout the disclosure. For example, a renter or landlord can access the web service interface for the rent reporting system 100 via an application or web browser on the mobile device 112, and the rental credit data can be uploaded to the server 106 for processing by the rent reporting system 100. Details regarding the processes performed by the rent reporting system 100 are discussed further herein.

In certain embodiments, the server 106 and/or database 108 can represent a cloud computing environment on which the processes described herein are implemented. The cloud computing environment may include one or more resource providers, such as the server 106 and/or database 108, and the like. Each resource provider may include computing resources. In some implementations, computing resources may include any hardware and/or software used to process data. For example, the computing resources may include hardware and/or software capable of executing algorithms, computer programs, and/or computer applications. In some implementations, exemplary computing resources may include application servers and/or databases with storage and retrieval capabilities. Each resource provider may be connected to any other resource provider in the cloud computing environment. In some implementations, the resource providers may be connected over the network 104. Each resource provider may also be connected to the computer 110, mobile device 112, and other client devices over the network 104.

The cloud computing environment may include a resource manager. The resource manager may be connected to the resource providers and the client devices over the network 104. In some implementations, the resource manager may facilitate the provision of computing resources by one or more resource providers to the client devices associated with renters, landlords, property manager, realtors, mortgage brokers, CRAs, credit bureaus, and the like. The resource manager may receive a request for a computing resource from a particular computing device, such as the computer 110. The resource manager may identify one or more resource providers capable of providing the computing resource requested by the client devices. The resource manager may select a resource provider to provide the computing resource. The resource manager may facilitate a connection between the resource provider and a particular client device. In some implementations, the resource manager may establish a connection between a particular resource provider and a particular client device. In some implementations, the resource manager may redirect a particular client device to a particular resource provider with the requested computing resource.

The backend computing devices 116 can also include one or more servers that are connected to the server 106, computer 110, mobile device 112, and/or database 108 via the network. The backend computing devices 116 can interchangeably be referred to as information storage servers. The backend computing devices 116 may be associated with loan origination software systems, CRAs, and/or credit bureaus with which the rent reporting system 100 communicates. For example, the server 106 may receive requests to report a renter's payment history to the credit bureau from backend computing devices 116 associated with the CRAs or the loan origination software (LOS). In addition, the server 106 may output the rental credit data to the backend computing devices 116 associated with the credit bureaus in order to have a rent reporting trade line added to a renter's credit report. The backend computing devices 116 may also be implemented in a cloud computing environment.

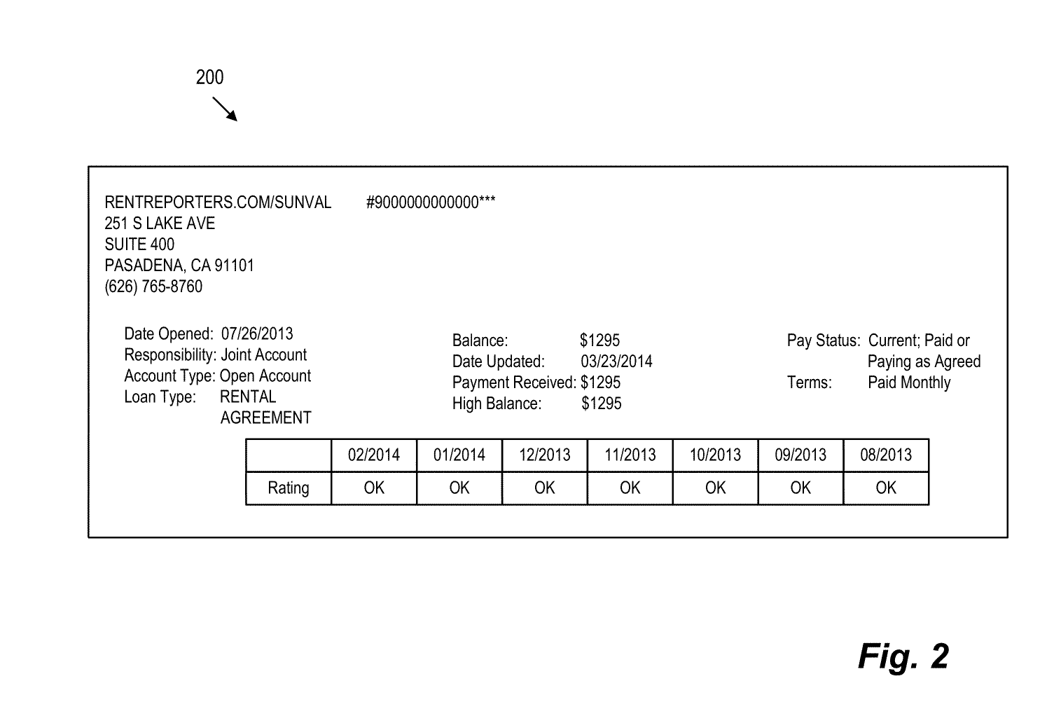

FIG. 2 is an exemplary diagram of a rent reporting trade line 200, according to certain embodiments. The rent reporting trade line 200 represents a result of the processes performed by the processing circuitry of the server 106 described further herein. For example, when the server 106 outputs validated and transformed rental credit data for a requestor, such as a renter, mortgage broker, or realtor to the credit bureaus, the rental credit data may be added as a TIER-1 trade line in the credit reports for the renter. In certain embodiments, TIER-1 trade lines in a credit report represent credit accounts that have a greater impact on a credit score or other type of credit analysis than other types of credit accounts. The rent reporting trade line 200 includes one or more elements of the rental credit data that indicate a current status of a renter's payment history. For example, the rent reporting trade line 200 includes the rental credit data, such as contact information for a reporting entity, an account opening date, account responsibility, account type, loan type, loan balance, date of most recent update, amount of payment received, high balance, pay status, and payment frequency. The rent reporting trade line 200 can also include rental payment history data for a predetermined number of months. For example, the rent reporting trade line 200 includes seven months of rental payment history data along with an associated rating. In one implementation, a rating of “OK” indicates that the renter paid a rent payment in full and on time.

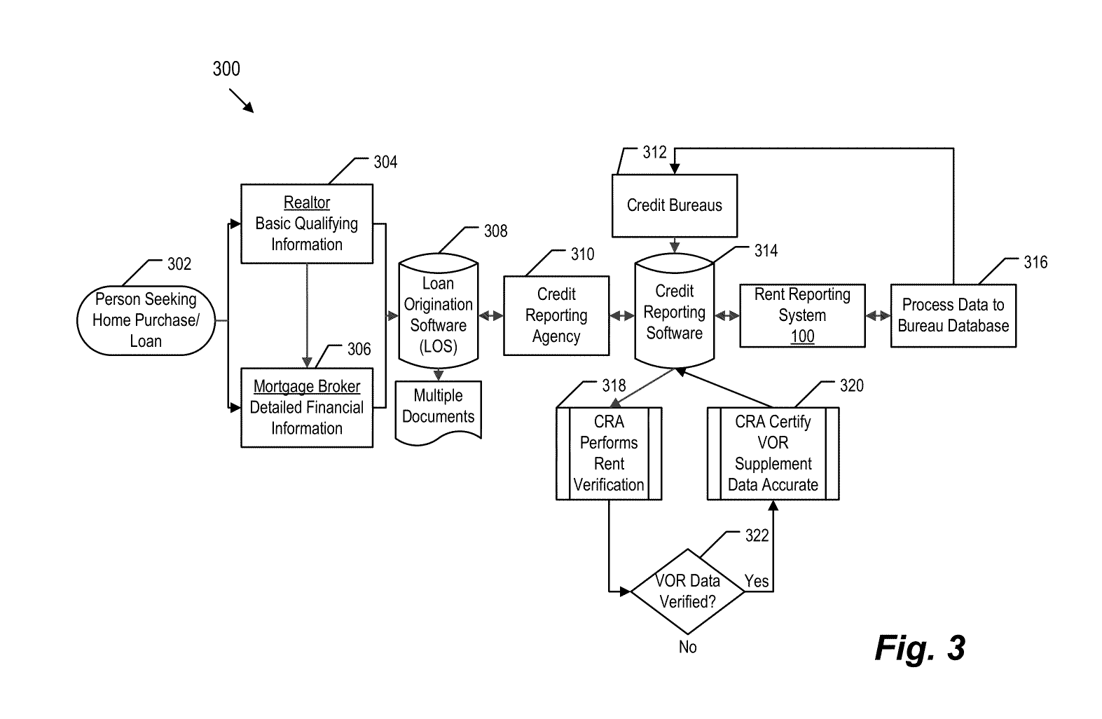

FIG. 3 is an exemplary functional block diagram of a lending industry structure 300, according to certain embodiments. The lending industry structure 300 shows the integration of the rent reporting system 100 within a mortgage qualifying process. In some implementations, a person seeking to purchase a home and/or obtain a loan 302, such as a renter, approaches a realtor 304 and/or mortgage broker 306 to initiate the loan. For example, the realtor 304 may input initial qualifying information, such as a yearly salary of the renter, down payment amount, and the like, at the LOS 308 interface at the computer 110. In addition, the mortgage broker 306 may input more detailed financial information, such as the type of loan, present housing payment, present monthly debt payments, home appraisal price, home sales price, rental data, and the like, at the LOS 308 interface at the computer 110. The LOS 308 outputs one or more loan documents based on the information input by the realtor 304 and the mortgage broker 306. For example, the documents can include an underwriting and transmittal summary document, such as a FNMA Form 1108/1003, and/or a verification of rent (VOR) form.

In some implementations, the LOS 308 also manages one or more processes associated with obtaining approval for a loan initiated by the realtor 304 or mortgage broker 306. For example, the LOS 308 can have data integration with credit reporting software 314 of one or more CRAs 310, such as MERIDIANLINK. The CRAs 310 function as third-party sales representatives for one or more credit bureaus 312, such as EXPERIAN, TRANSUNION, EQUIFAX, and any other credit bureau. When a loan request is initiated, the LOS 308 can directly access the credit reports for the renter 302 via the CRAs 310. Upon review of the credit report, the realtor 304 and/or mortgage lender may determine whether quality of the credit reports and current status of the renter 302 warrant performing a verification of rent (VOR). In addition, the integration between the LOS 308 and the credit reporting software 314 allows the LOS 308 to pull credit report information into the LOS 308.

The LOS 308 can also make requests of the CRAs 310 to perform one or more verification functions, including verification of rent, employment, deposit, taxes, and other data input at the LOS 308. For example, based on rental data received from the LOS 308, the credit reporting software 314 performs a verification of one or more rental payments 318. If the VOR data is verified to be accurate 322, then the CRA 310 certifies the VOR data as 320. The rent reporting system 100 can also integrate the credit reporting software 314 to access credit reports and transmit rental credit data, which can be added as a trade line on the credit reports. In some implementations, processed data 316 output by the rent reporting system 100 is output to secure networks associated with the credit bureaus 312.

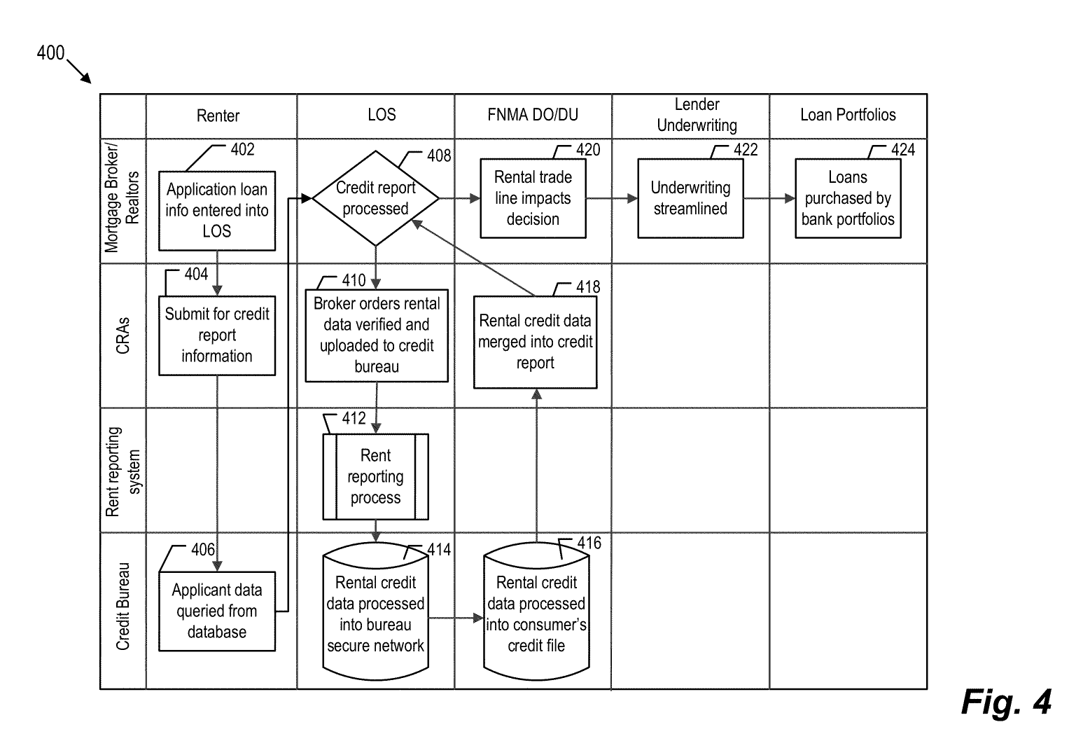

FIG. 4 is a block diagram of an exemplary loan approval process 400, according to certain embodiments. The steps of the loan approval process 400 are overlaid on a table that illustrates one or more participants associated with each step of the loan approval process 400. For example, at step 402, the mortgage brokers 306, realtors 304, and/or renters 302 initiate a loan application by entering information, such as the rental credit data, into the LOS interface at the computer 110. For example, the realtor 304 may input initial qualifying information, such as a yearly salary of the renter, down payment amount, and the like, at the LOS 308 interface at the computer 110. In addition, the mortgage broker 306 may input more detailed financial information, such as the type of loan, present housing payment, present monthly debt payments, home appraisal price, home sales price, rental data, and the like. At step 404, credit report information is requested from the CRAs 310 via the LOS 308 to determine credit-worthiness of the renter 302, and at step 406, applicant data is queried from a database at the credit bureau 312 to retrieve the credit report.

At step 408, the retrieved credit report is returned to the mortgage brokers 306, realtors 304, and/or renters 302 for processing to determine whether adding the rent reporting trade line 200 to the renter's credit report may improve the quality of the credit report and/or improve the credit score. In some implementations, the processing circuitry of the server 106 executes one or more software processes to determine a projected credit score improvement based on learned trends from previously processed loans where the credit reports included the rent reporting trade line 200. For example, the database 108 can store historical credit report data that include credit reports for renters with and without the rent payment data included in the rent reporting trade line. The processing circuitry of the server 106 can execute one or more software processes to determine credit score estimates with and without the rent payment data included, and the projected credit score improvement is a difference between the estimated credit score including the rent payment data and the estimated credit score without the rent payment data. In some implementations, the server 106 determines the credit score estimates based on one or more credit categories including amounts owed, payment history which may include the rental payment history, new credit length of credit history, and/or credit mix. The credit score estimates may be calculated based on learned trends and historical data from previous implementations of the rent reporting system 100 as well as an impact of each of the credit categories on other types of credit scores, such as a FICO credit score.

In some implementations, the processing circuitry may determine categorical groupings for the historical credit report data based on the credit categories as well as the submitted rental credit data. For example, credit reports may be grouped based on a number of missed and/or late rental payments over a predetermined period time, such as twenty-four months. Credit reports associated with renters who have zero missed and/or late payments may be in a first group, renters who have missed and/or been late with one to five payments may be in a second group, and the like. In addition, the processing circuitry may also group the credit reports stored in the database 108 according to the other credit categories. The processing circuitry can determine relative weighting factors for the credit categories, including the rental payment data, based on the credit report groupings.

In addition, the processing circuitry of the server 106 can also determine a projected amount of change in a loan approval amount based on the projected credit score improvement. For example, the database 108 may store loan approval amounts for each credit report processed by the rent reporting system 100 which is used by the processing circuitry to determine how much adding the rent reporting trade line 200 impacts the loan approval amount. In some implementations, the processing circuitry may determine that adding the rent reporting trade line 200 may increase the loan approval amount above a predetermined target amount, which indicates that adding the rent reporting trade line 200 to the credit report may be beneficial for the renter who is attempting to obtain a mortgage.

If it is determined that the quality of the credit report and/or credit score may be improved by adding the rent reporting trade line to the credit report, then at step 410, the mortgage broker 306 may initiate a request via an interface at the computer 110 to provide a rent report to the credit bureaus 312 to add the rental credit data as a trade line on the credit reports. The processing circuitry of the server 106 determines an enrollment path for the initiation request based on an originating enrollment venue for the initiation request. For example, the initiation request can be routed to the rent reporting system 100 from the LOS 308, from a credit reporting software interface for the CRAs 310, or directly from a direct enrollment website.

At step 412, the rent reporting system 100 receives the initiation request, and the processing circuitry of the server 106 performs a rent reporting process. The server 106 processes the rental credit data received from one of the enrollment paths, and the rental credit data is transformed to a predetermined format corresponding to the format of the credit reports for the credit bureaus 312, and the rental credit data is output to the credit bureaus 312 via a file transfer protocol (FTP). Details regarding the rent reporting process of step 412 are discussed further herein.

At step 414, the transformed rental credit data is delivered to the credit bureaus 312 and is stored in a database associated with a bureau secure network, and at step 416, one or more computing devices, such as servers, associated with the credit bureaus 312 process the rental credit data into the renter's credit file. At step 418, the CRAs 408 merge the rental credit data into the credit report of the renter and delivers the credit report with the updated rent reporting trade line to the renter 302, realtor 304, and/or mortgage broker 306. At step 418, the rent reporting trade line 200 on the credit report of the renter may impact a loan approval decision when the rental payment history provides evidence that rent payments have been submitted on time over a period of time. At step 422 underwriting may be streamlined for the mortgage broker 306 because the rent reporting trade line 200 provides verified rental payment history data without having to perform manual rent payment verification. At step 424, loans purchases by bank portfolios may be based in part on the rent reporting trade line 200 added to the credit reports by the rent reporting system 100.

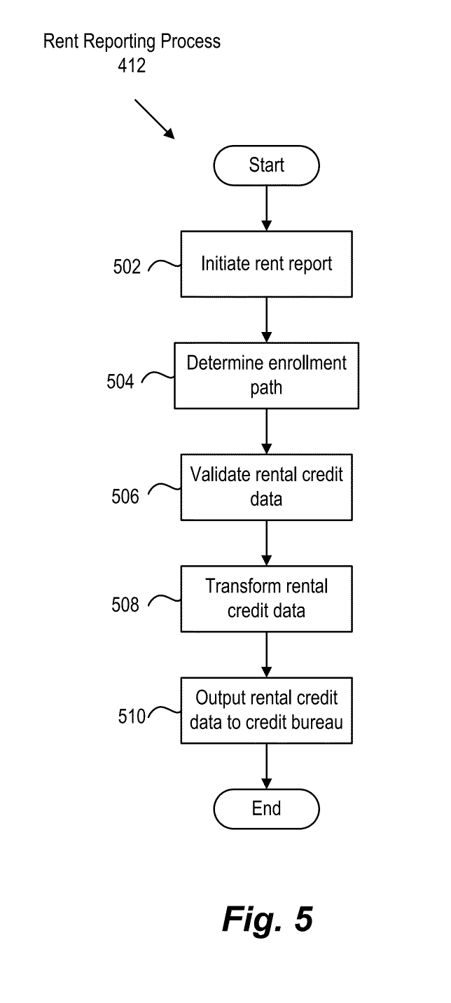

FIG. 5 is a flowchart of the rent reporting process of step 412 of the loan approval process 400, according to certain embodiments. At step 502, a credit bureau rent report is initiated by the processing circuitry of the server 106 in response to receiving an initiation request from a client device. In some implementations, the initiation request from the client device corresponds to a request from the realtor 304, mortgage broker 306, renter 302, landlord, property manager, and the like, to report a rental payment history to the credit bureaus 312 in order to have the rent reporting trade line 200 added to the credit reports for the credit bureaus. Throughout the disclosure, the person initiating the request is interchangeably referred to as the requestor. For example, the renter 302 may approach the mortgage broker 306 to initiate a request for a mortgage, and the mortgage broker 306 fills out one or more loan request documents, such as the underwriting and transmittal summary document, such as a FNMA Form 1108/1003, a verification of rent (VOR) document, and/or any other type of loan-initiation document via the LOS interface screen at the client device. The LOS interface screen may include a credit rent report selection for the requestor to request initiation of the credit rent report, which includes the rental credit data of the renter 302. The requestor can also initiate the request at a credit reporting software interface screen associated with one or more CRAs 310.

In some implementations, the requestor can also initiate the request to report the rental payment data at a web service interface directly connected to the server 106 of the rent reporting system 100. The web service interface can include a REST API and/or a SOAP API. For example, the renter 302, landlord, or property manager can provide enrollment information at the web interface, which may include providing identification information as well as information associated with the rental payment transactions, such as an address, a rent amount, duration of a rental lease, property ownership, renter/landlord identity information, and the like. In one implementation, the renter 302 can directly initiate the request to report the rental credit data to the credit bureaus 312 at the web interface without validation or assistance from a third party, such as the mortgage broker 306, landlord, and the like. The server 106 processes and validates the enrollment information provided by the requester, and a user account is generated. In some implementations, the requestor can input the rental payment data at the web service interface on a recurring basis as the renter 302 submits rent payments to the landlord and/or property manager. In other implementations, the requester may input rental payment history data for a plurality of months at the web service interface.

At step 504, the processing circuitry of the server 106 determines an enrollment path for the rent report based on an originating enrollment venue associated with the initiation request. According to certain embodiments, the originating enrollment venue corresponds to a location where the request to report the rental payment data to the credit bureaus 312 has been initiated. For example, the enrollment paths include a direct enrollment path, a loan origination enrollment path, and a CRA enrollment path. For example, the direct enrollment path is associated with requests initiated at a direct enrollment website interface associated with the rent reporting system 100. When the request is initiated at the web service interface, the processing circuitry routes the rental credit data from the web service to the server 106 for processing.

In addition, the loan origination enrollment path is associated with requests initiated via the LOS 308. When the request is initiated at the LOS 308, the rental credit data input at the LOS interface screen is transmitted from the LOS interface to the server 106 via a network connection between one or more computing devices, such as servers, associated with the LOS 308 and the server 106 of the rent reporting system 100. In some implementations, when the loan origination documents are completed by the requestor at the LOS interface screen, the processing circuitry of the server 106 can extract the rental credit data from one or more data fields of the loan origination documents. In some implementations, the CRA enrollment path is associated with requests initiated via the credit reporting software interface associated with the CRAs 310. When the request is initiated at the CRAs, the rental credit data input at the credit reporting software interface screen is transmitted from the credit reporting software interface to the server 106 via a network connection between one or more computing devices, such as servers, associated with the CRAs 310 and the server 106 of the rent reporting system 100.

At step S506, the processing circuitry of the server 106 performs a validation of one or more elements of the rental credit data based on one or more validation criteria. For example, the validation criteria can include determining a confidence level for the elements of the rental credit data submitted by the requestor, such as the property data, ownership data, property management data, renter identity data, rental payment history data, and the electronic signature by performing data mining processes, web crawling processes, and the like, to validate the provided rental credit data with stored files in the database 108, websites, and data provided by the credit bureaus. The confidence level can be a score from one to ten, one to one hundred, or any other range. For example, the processing circuitry can access property ownership records from the database 108 to determine if the property ownership records correspond to the submitted property data. If a name of a property owner specified in the property ownership documents corresponds to a submitted property owner name, then the processing circuitry may assign a confidence level of one hundred to the property owner information. If the confidence level for the elements of the rental credit data is greater than a predetermined threshold, then the processing circuitry determines that the rental credit data is valid.

At step 508, the rental credit data is transformed into a predetermined format corresponding to one or more credit bureau report formats. In some implementations, the processing circuitry of the server 106 transforms the rental credit data to one or more standardized formats that correspond to the processes and/or data used by the computing devices of the credit bureaus 312, such as EXPERIAN, TRANSUNION, EQUIFAX, to add the rent reporting trade line 200 to the credit reports. According to certain embodiments, the transformation of the rental credit data includes associating each element of the rental credit data with a field of a standardized credit reporting format, such as the METRO 2 format. For example, the METRO 2 credit reporting format includes one or more data fields, such as an account type, a credit limit, account status, current balance, billing date, and the like. The processing circuitry of the server 106 may assign each element of the rental credit data to one or more of the data fields so that the rental credit data can be processed by the credit bureaus 312 and added to the credit reports. In some implementations, the processing circuitry derives the values for the fields of the standardized credit reporting format by converting the elements of the rental credit data to values that correspond to the credit reporting format. For example, the processing circuitry may determine that the current balance field of the METRO 2 format corresponds to a monthly rent payment amount, and the credit limit field can be derived by multiplying the current number of months left on a rental lease by the monthly rent payment amount.

At step 510, the processing circuitry of the server 106 outputs the transformed rental credit data to one or more computing devices associated with the credit bureaus 312. In some implementations, the processing circuitry transmits the rental credit data to the credit bureaus via FTP. In addition, the server 106 may output the rental payment history data covering a predetermined period of time, such as twenty-four months. In another implementation, the server 106 may output the rental credit data to the credit bureaus 312 on a recurring basis in response to processing of rent payments and input via the web service interface for the rent reporting system 100.

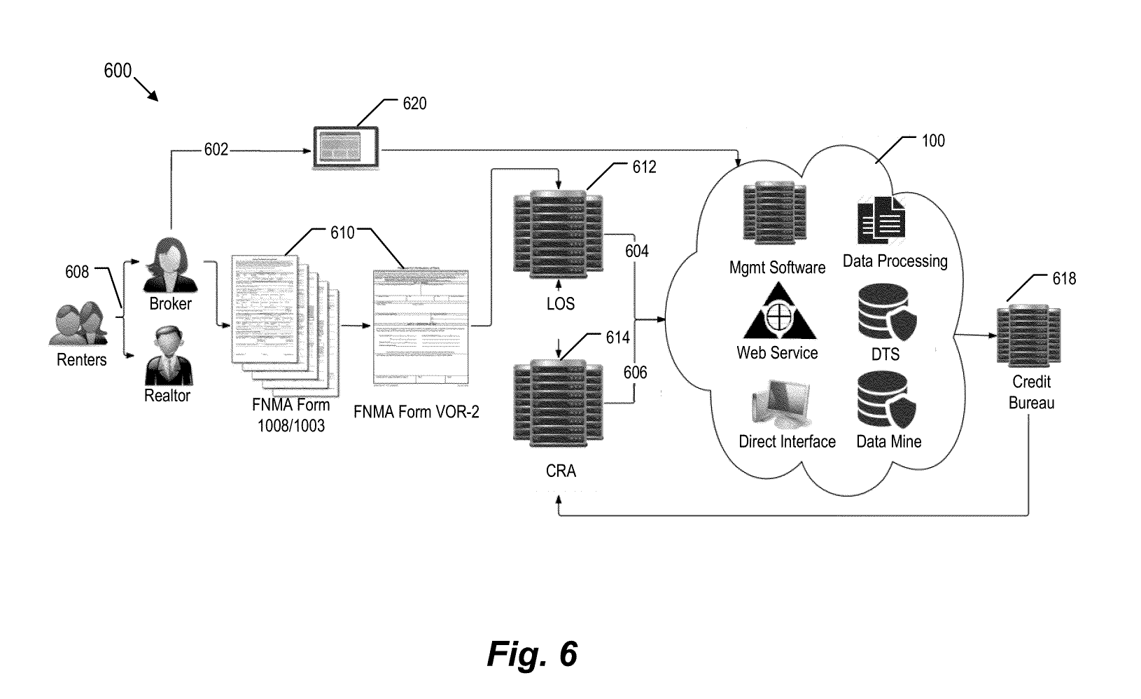

FIG. 6 is a diagram 600 illustrating the enrollment paths of the rent reporting system 100, according to certain embodiments. In some implementations, the enrollment path for the rent report is based on an originating enrollment venue associated with the initiation request. According to certain embodiments, the originating enrollment venue corresponds to a location where the request to report the rental payment data to the credit bureaus 312 has been initiated. For example, the enrollment paths include a direct enrollment path 602, a loan origination enrollment path 604, and a CRA enrollment path 606. For example, the direct enrollment path is used when a requestor 608, such as a renter, broker, or realtor, initiates a request to add the rental payment history data to the credit reports at the web service interface 620 associated with the rent reporting system 100. When the request is initiated at the web service interface 620, the processing circuitry routes the rental credit data from the web service to the server 106 for processing.

In addition, the loan origination enrollment path 604 is associated with requests initiated via the LOS 308 associated with one or more LOS computing devices 612. When the request is initiated, the rental credit data input at the LOS interface screen is transmitted from the LOS computing devices 612 to the server 106 of the rent reporting system 100 via a network connection. In some implementations, when the loan origination documents 610 are completed by the requestor 608 at the LOS interface screen, the processing circuitry of the server 106 can extract the rental credit data from one or more data fields of the loan origination documents 610. In some implementations, the CRA enrollment path 606 is associated with requests initiated via the credit reporting software interface associated with one or more CRA computing devices 614. When the request is initiated at the CRA, the rental credit data input at the credit reporting software interface screen is transmitted from the CRA computing devices 614 to the server 106 of the rent reporting system 100 via a network connection.

The diagram 600 of FIG. 6 also illustrates processing and interface tools associated with the rent reporting system 100. For example, the rent reporting system 100 can include management software executed by the processing circuitry of the server 106 that controls the execution of the processes of the rent reporting system 100. The rent reporting system 100 also includes a web service as well as a direct consumer interface that allows requestors to initiate reporting of rental credit data to the credit bureaus 618 via the direct enrollment path 620. In addition, data processing tools, a data transformation service (DTS), and a data mine include one or more software processes executed by the processing circuitry of the server 106 that are associated with the rent reporting process 412 described previously herein. For example, the data processing tools and data mining tools are associated with the data validation of step 506, and the DTS tool is associated with the data transformation step 508. In addition, the rental credit data that is validated and transformed by the rent reporting system 100 is output to computing devices associated with the credit bureaus 618, which in return the credit reports updated with the rental trade line 200 to the CRAs 614.

A hardware description of an exemplary server 106 for performing one or more of the implementations described herein is described with reference to FIG. 7. In addition, the hardware described by FIG. 7 can also apply to the computer 110, the mobile device 112, and/or the backend computing devices 116. When the server 106, computer 110, mobile device 112, and/or backend computing devices 116 are programmed to perform the processes related to rent reporting described herein, the server 106, computer 110, mobile device 112, and/or backend computing devices 116 become a special purpose device. Implementation of the processes of the rent reporting system 100 on the hardware described herein improves the efficiency of mortgage underwriting by gathering and/or receiving rental credit data for a prospective home buyer, validating and transforming the rental credit data to predetermined formats, and outputting the rental credit data to the credit bureaus to be added as a trade line on the credit bureau reports.

The server 106 includes a CPU 700 that perform the processes described herein. The process data and instructions may be stored in memory 702. These processes and instructions may also be stored on a storage medium disk 704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 106 communicates, such as the computer 110, database 108, and/or mobile device 112.

Further, the claimed advancements may be provided as a utility application, background daemon, or component of an operating system, or combination thereof, executing in conjunction with CPU 700 and an operating system such as Microsoft Windows, UNIX, Solaris, LINUX, Apple MAC-OS and other systems known to those skilled in the art.

CPU 700 may be a Xenon or Core processor from Intel of America or an Opteron processor from AMD of America, or may be other processor types that would be recognized by one of ordinary skill in the art. Alternatively, the CPU 700 may be implemented on an FPGA, ASIC, PLD or using discrete logic circuits, as one of ordinary skill in the art would recognize. Further, CPU 700 may be implemented as multiple processors cooperatively working in parallel to perform the instructions of the inventive processes described above.

The server 106 in FIG. 7 also includes a network controller 706, such as an Intel Ethernet PRO network interface card from Intel Corporation of America, for interfacing with network 104. As can be appreciated, the network 104 can be a public network, such as the Internet, or a private network such as an LAN or WAN network, or any combination thereof and can also include PSTN or ISDN sub-networks. The network 104 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The server 106 further includes a display controller 708, such as a NVIDIA GeForce GTX or Quadro graphics adaptor from NVIDIA Corporation of America for interfacing with display 710 of the server 106, such as an LCD monitor. A general purpose I/O interface 712 at the server 106 interface with a keyboard and/or mouse 714 as well as a touch screen panel 716 on or separate from display 710. General purpose I/O interface 712 also connects to a variety of peripherals 718 including printers and scanners.

A sound controller 720 is also provided in the server 106, such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the server 106. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

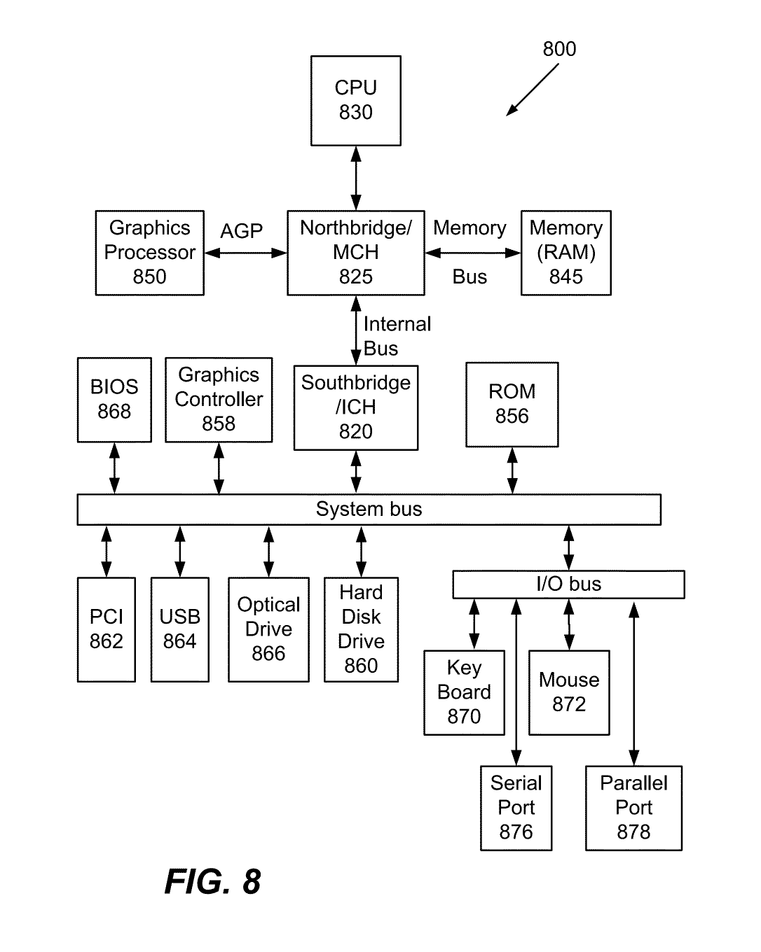

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 8.

FIG. 8 shows a schematic diagram of a data processing system, according to one example, for performing the processes described herein. The data processing system is an example of a computer in which code or instructions implementing the processes of the illustrative implementations may be located.

In FIG. 8, data processing system 800 employs a hub architecture including a north bridge and memory controller hub (NB/MCH) 825 and a south bridge and input/output (I/O) controller hub (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU Processing unit 830 may contain one or more processors and even may be implemented using one or more heterogeneous processor systems.

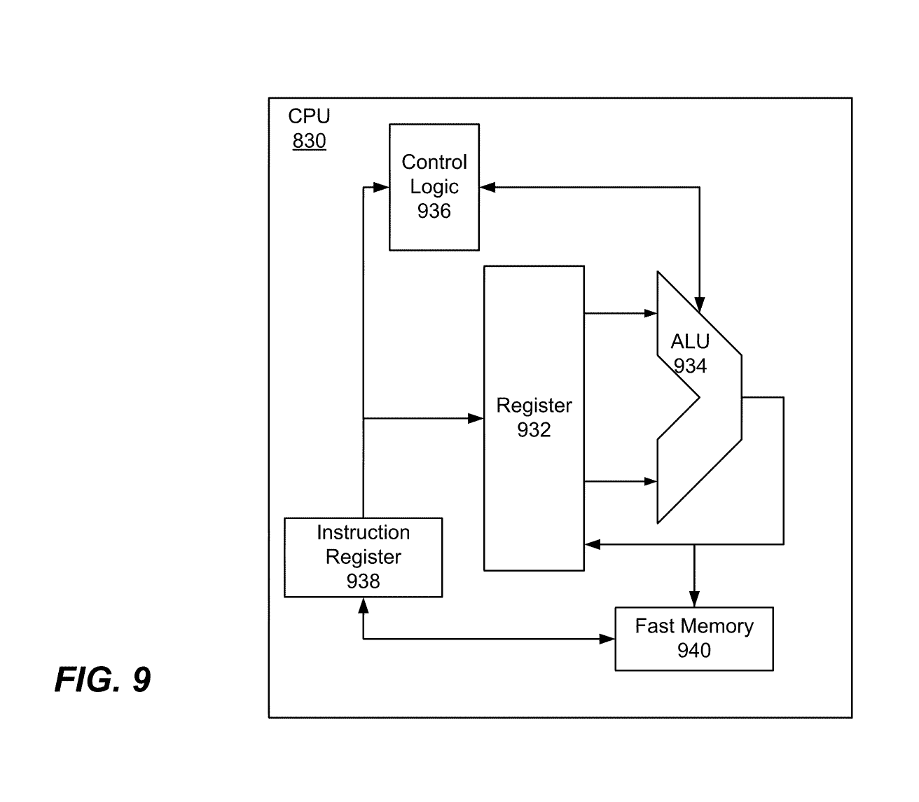

For example, FIG. 9 shows one implementation of CPU 830. In one implementation, the instruction register 938 retrieves instructions from the fast memory 940. At least part of these instructions are fetched from the instruction register 938 by the control logic 936 and interpreted according to the instruction set architecture of the CPU 830. Part of the instructions can also be directed to the register 932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 934 that loads values from the register 932 and performs logical and mathematical operations on the loaded values according to the instructions. The results from these operations can be feedback into the register and/or stored in the fast memory 940. According to certain implementations, the instruction set architecture of the CPU 830 can use a reduced instruction set architecture, a complex instruction set architecture, a vector processor architecture, a very large instruction word architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 8, the data processing system 800 can include that the SB/ICH 820 is coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH YYY through a PCI bus 862.

The PCI devices may include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bust through the I/O bus. Other peripherals and devices that can be connected to the SB/ICH 820 using a mass storage controller such as SATA or PATA, an Ethernet port, an ISA bus, a LPC bridge, SMBus, a DMA controller, and an Audio Codec.

The processes described herein can also be applied to other types of technologies and improve the technical field of technologies that include adding supplemental data to existing processes and/or documentation. Thus, the server 106 can implement the features described herein to provide the above-noted advantages. Accordingly, the server 106 is not merely a generic computer performing well known generic functions but is instead a special purpose machine specifically programmed to carry out the novel features described herein. Thus, the features described herein do not relate to an abstract idea and regardless they represent significantly more than any abstract idea.

Traditionally, rent payments have not been included in credit reports because rental contracts may not be considered to be a conventional debt such as a revolving credit account, installment loan, or other type of credit account that is reported to the credit bureaus in the standardized format. For example, negative rent payment data, such as when a rent payment is received late or a lease is broken, may be reported to the credit bureaus as a conventional debt when taken over by a collections agency. Electronic reporting of credit information to the credit bureaus via one or more computing devices allows for the addition of the rent reporting trade line to the credit reports by validating and transforming the rental credit data to the standardized format according to the embodiments described previously herein.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The implementations of the present disclosure were chosen and described in order to best explain the principles of the disclosure and the practical application, and to enable others of ordinary skill in the art to understand the disclosure for various implementations with various modifications as are suited to the particular use contemplated.

The above disclosure also encompasses the aspects listed below.

(1) A device for managing a flow of data between information storage servers of information storage entities, including: circuitry configured to initiate, in response to receiving an initiation request from a client device, a rent report including the data, determine an enrollment path for the rent report based on an originating enrollment venue associated with the initiation request, validate one or more elements of the data based on one or more validation criteria, transform the data to a predetermined format corresponding to one or more report formats, and output the data to one of the information storage servers associated with one of the information storage entities.

(2) The device of (1), wherein the circuitry is further configured to process the data via a web service interface.

(3) The device of (1) or (2), wherein the web service interface includes a representational state transfer (REST) application program interface (API) or a simple object access protocol (SOAP) API.

(4) The device of any one of (1) to (3), wherein the circuitry is further configured to output the data to the information storage servers of the information storage entities via a file transfer protocol (FTP).

(5) The device of any one of (1) to (4), wherein the circuitry is further configured to output the data in a TIER-I trade line format.

(6) The device of any one of (1) to (5), wherein the circuitry is further configured to output the data covering a predetermined period of time.

(7) The device of any one of (1) to (6), wherein the circuitry is further configured to determine a projected credit score improvement based on adding the data to a credit report of a renter.

(8) The device of any one of (1) to (7), wherein the circuitry is further configured to determine the projected credit score improvement based on categorical groupings of historical report data.

(9) The device of any one of (1) to (8), wherein the circuitry is further configured to determine a projected amount of change in an approval amount based on the projected credit score improvement.

(10) The device of any one of (1) to (9), wherein the circuitry is further configured to assign one or more elements of the data to one or more data fields of a standardized reporting format.

(11) The device of any one of (1) to (10), wherein the enrollment path includes a direct enrollment path, a loan origination enrollment path, and a reporting agency enrollment path.

(12) The device of any one of (1) to (11), wherein the circuitry is further configured to route the rent report through the direct enrollment path when the originating enrollment venue corresponds to a direct enrollment website.

(13) The device of any one of (1) to (12), wherein the circuitry is further configured to route the rent report through the loan origination enrollment path when the originating enrollment venue corresponds to a loan origination software interface.

(14) The device of any one of (1) to (13), wherein the circuitry is further configured to route the rent report through the reporting agency enrollment path when the originating enrollment venue corresponds to a reporting software interface.

(15) The device of any one of (1) to (14), wherein the data includes property data, ownership data, management data, renter identity data, rental payment history data, or an electronic signature.

(16) The device of any one of (1) to (15), wherein the circuitry is further configured to output the rental payment history data to the information storage serves associated with the information storage entities on a recurring basis in response to processing a rental payment.

(17) The device of any one of (1) to (16), wherein the circuitry is further configured to extract the data from one or more loan origination documents.

(18) The device of any one of (1) to (17), wherein the initiation request corresponds to a request to report payment history to the information storage entities by brokers, realtors, landlords, or renters.

(19) A method for managing a flow of data between information storage servers of information storage entities, including: initiating, via a server, in response to receiving an initiation request from a client device, a rent report including the data; determining, via the server, an enrollment path for the rent report based on an originating enrollment venue associated with the initiation request; validating, via the server, one or more elements of the data based on one or more validation criteria; transforming, via the server, the data to a predetermined format corresponding to one or more report formats; and outputting, via the server, the data to one of the information storage servers associated with one of the information storage entities.

(20) A non-transitory computer-readable medium having computer-readable instructions thereon which when executed by a computer cause the computer to perform a method for managing a flow of data between information storage servers of information storage entities, the method including: initiating, via a server, in response to receiving an initiation request from a client device, a rent report including the data; determining an enrollment path for the rent report based on an originating enrollment venue associated with the initiation request; validating one or more elements of the data based on one or more validation criteria; transforming the data to a predetermined format corresponding to one or more report formats; and outputting the data to one of the information storage servers associated with one of the information storage entities.

1. A device for managing a flow of data between information storage servers of information storage entities, comprising:
circuitry configured to
initiate, in response to receiving an initiation request from a client device, a rent report including the data,
determine an enrollment path for the rent report based on an originating enrollment venue associated with the initiation request,
validate one or more elements of the data based on one or more validation criteria,
transform the data to a predetermined format corresponding to one or more report formats, and
output the data to one of the information storage servers associated with one of the information storage entities.

2. The device of claim 1, wherein the circuitry is further configured to process the data via a web service interface.

3. The device of claim 2, wherein the web service interface includes a representational state transfer (REST) application program interface (API) or a simple object access protocol (SOAP) API.

4. The device of claim 1, wherein the circuitry is further configured to output the data to the information storage servers of the information storage entities via a file transfer protocol (FTP).

5. The device of claim 1, wherein the circuitry is further configured to output the data in a TIER-I trade line format.

6. The device of claim 1, wherein the circuitry is further configured to output the data covering a predetermined period of time.

7. The device of claim 1, wherein the circuitry is further configured to determine a projected credit score improvement based on adding the data to a credit report of a renter.

8. The device of claim 7, wherein the circuitry is further configured to determine the projected credit score improvement based on categorical groupings of historical report data.

9. The device of claim 7, wherein the circuitry is further configured to determine a projected amount of change in an approval amount based on the projected credit score improvement.

10. The device of claim 1, wherein the circuitry is further configured to assign one or more elements of the data to one or more data fields of a standardized reporting format.

11. The device of claim 1, wherein the enrollment path includes a direct enrollment path, a loan origination enrollment path, and a reporting agency enrollment path.

12. The device of claim 11, wherein the circuitry is further configured to route the rent report through the direct enrollment path when the originating enrollment venue corresponds to a direct enrollment website.

13. The device of claim 11, wherein the circuitry is further configured to route the rent report through the loan origination enrollment path when the originating enrollment venue corresponds to a loan origination software interface.

14. The device of claim 11, wherein the circuitry is further configured to route the rent report through the reporting agency enrollment path when the originating enrollment venue corresponds to a reporting software interface.

15. The device of claim 1, wherein the data includes property data, ownership data, management data, renter identity data, rental payment history data, or an electronic signature.

16. The device of claim 15, wherein the circuitry is further configured to output the rental payment history data to the information storage serves associated with the information storage entities on a recurring basis in response to processing a rental payment.

17. The device of claim 1, wherein the circuitry is further configured to extract the data from one or more loan origination documents.

18. The device of claim 1, wherein the initiation request corresponds to a request to report payment history to the information storage entities by brokers, realtors, landlords, or renters.

19. A method for managing a flow of data between information storage servers of information storage entities, comprising:
initiating, via a server, in response to receiving an initiation request from a client device, a rent report including the data;
determining, via the server, an enrollment path for the rent report based on an originating enrollment venue associated with the initiation request;
validating, via the server, one or more elements of the data based on one or more validation criteria;
transforming, via the server, the data to a predetermined format corresponding to one or more report formats; and
outputting, via the server, the data to one of the information storage servers associated with one of the information storage entities.

20. A non-transitory computer-readable medium having computer-readable instructions thereon which when executed by a computer cause the computer to perform a method for managing a flow of data between information storage servers and information storage entities, the method comprising:
initiating, via a server, in response to receiving an initiation request from a client device, a rent report including the data;
determining an enrollment path for the rent report based on an originating enrollment venue associated with the initiation request;
validating one or more elements of the data based on one or more validation criteria;
transforming the data to a predetermined format corresponding to one or more report formats; and
outputting the data to one of the information storage servers associated with one of the information storage entities.
